(19) United States
(12) Patent Application Publication
(10) Pub. No.: US 2002/0071447 A1
(43) Pub. Date: Jun. 13, 2002

(54) Line terminating equipment

(76) Inventors: Tomohiro Shinomiya, Kawasaki (JP); Nagao Shimada, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/010,419

(22) Filed: Dec. 6, 2001

(30) Foreign Application Priority Data
Dec. 7, 2000 (JP) 2000-372803

(51) Int. Cl. H04B 7/212

(52) U.S. Cl. 370/444; 370/468

(57) ABSTRACT

The present invention relates to a line terminating equipment for allotting a transmission bandwidth to a plurality of terminals at one end of a subscriber line section of an access network. In the line terminating equipment, requisite bandwidths of the individual terminals are computed as an increasing function of receipt information content which is content of transmission information precedingly received from the terminals and untransmitted information content notified by the terminals. The transmission bandwidth to be allotted to each terminal is determined in a manner which is decided according to a comparison result of magnitude between a total requisite bandwidth and a transmission bandwidth of a transmission channel. Therefore, in a communication system to which the present invention is applied, the transmission bandwidth is allotted effectively, flexibly, and efficiently to all the terminals, which enhances total reliability as well as service quality and transmission quality.

### BACKGROUND OF THE INVENTION

1. Field of the Invention

The present invention relates to line terminating equipment which is disposed at one end of a subscriber line section of an access network and appropriately allots a transmission band to a plurality of terminals accommodated via the subscriber line section based on a predetermined signaling system and a communication protocol.

2. Description of the Related Art

In recent years, the technology of realizing performance improvement and cost reduction of equipment constituting an optical transmission system and a high-quality transmission technology which realizes flexible adaptability to various transmission information and services have been established, and these technologies are being widely applied not only to a trunk line system but also to a subscriber line section of an access network such as a TPON (Telephony Passive Optical Network) and a BPON (Broadband Passive Optical Network).

FIG. 10 is a diagram showing a structure example of an ATM-PON system.

As shown in FIG. 10, a plurality of network units 80-1 to 80-N are connected to line terminating equipment 50 via full duplex optical transmission paths 71-U and 71-D which are formed in an astero-shape via splitters 70-U and 70-D.

The line terminating equipment 50 is composed of the following components.

an individual information table 51 and a sharable information table 52 in which later described information is stored in advance

a polling-message generating part 53F and a controlling part 54 which are connected to the individual information table 51 and the sharable information table 52 via a bus

a polling-message generating part 53C connected to a specific output port of the controlling part 54

polling buffers 55F, 55C connected in series to outputs of the polling-message generating parts 53F, 53C respectively

a divided slot generating part 56

a polling-message multiplexing part 57 having three inputs connected to outputs of the polling buffers 55F, 55C and the divided slot generating part 56 respectively

a downstream multiplexing part 58 with one input thereof being connected to an output of the polling-message multiplexing part 57, the other input being given downstream transmission information to be transmitted to either one of the network units 80-1 to 80-N, and an output thereof being connected to one end of the optical transmission path 71-D

a polling-request extracting part 59 having an input connected to one end of the optical transmission path 71-U and an output connected to a predetermined input port of the controlling part 54 and a write input of the individual information table 51, and outputting upstream information which is received from either one of the network units 80-1 to 80-N via the optical transmission path 71-U

The network unit 80-1 is composed of the following components. a polling-information extracting part 81-1 connected to the other end of the optical transmission path 71-D and outputting the aforesaid downstream transmission information

a transmission buffer 82F-1 in which upstream transmission information to be transmitted via a later described static band (hereinafter called simply as ‘high-priority information’) is accumulated

a transmission buffer 82C-1 in which upstream transmission information to be transmitted via a later described sharable band (hereinafter called simply ‘low-priority information’) is accumulated

a buffer reading part 83-1 having three inputs connected to outputs of the transmission buffers 82F-1, 82C-1 and a monitor terminal of the polling-information extracting part 81-1 respectively

a buffer-length determining part 84-1 and a polling-request generating part 85-1 cascaded to a monitor output of the transmission buffer 82-C-1

an upstream multiplexing part 86-1 having two inputs connected to outputs of the buffer reading part 83-1 and the polling-request generating part 85-1 respectively and an output connected to a corresponding other end of the optical transmission path 71-U

Note that since the structures of the network units 80-2 to 80-N are the same as those of the network unit 80-1, the same reference numerals with added numbers ‘2’ to ‘N’ are used below to represent corresponding components for simplicity and they are not explained or shown here.

In the ATM-PON system as structured above, the following information is stored in advance in the sharable information table 52 which is provided in the line terminating equipment 50.

a maximum transmission bandwidth (hereinafter called simply an ‘aggregate bandwidth’) Bₐ which can be allotted to the network units 80-1 to 80-N, out of a transmission bandwidth of the optical transmission path 70-U (FIG. 11 (1))

the number of a ‘bandwidth-update slot’ S given as a ratio of a cycle T at which the transmission bandwidth allotted to the network units 80-1 to 80-N is to be updated under the control of the line terminating equipment 50 to a length of a time slot (here, supposed to be given as a fixed value t for simplicity) given under a transmission system of the optical transmission path 70-U

a sum total (hereinafter called an upper limit of total-sharable-bandwidth') (FIG. 11 (3)) of transmission bandwidths (hereinafter called a ‘sharable band’) which is given as a difference between the ‘aggregate bandwidth’ and a sum total of minimum transmission bandwidths to be individually allotted to the network units 80-1 to 80-N (hereinafter simply called a ‘static band’) (FIG. 11 (2))

weight coefficients α, β which are described later

In a specific storage area out of storage areas of the individual information table 51, individual static bands B_{f1} to B_{fN} (FIG. 11(a)) to be allotted individually as the static bands to the network units 80-1 to 80-N are stored in advance and in other storage areas, storage areas which store therein the following information individually corresponding to the network units 80-1 to 80-N are disposed.

the number of cells (transmission information) C_{B} which are accumulated in the transmission buffers 82C-1 to 82C-N provided in the network units 80-1 to 80-N and which are to be transmitted to the line terminating equipment 50 via the optical transmission path 71-U (hereinafter called simply ‘information content in a buffer’)

‘record-depending bandwidth’ computed by the controlling part 54 as described later

Note that, hereinafter, items common to all the network units 80-1 to 80-N are described with an added character ‘c’, which signifies that it corresponds to the added numbers ‘1’ to ‘N’, being added to a reference numeral of each component.

In the network unit 80-c, the high-priority information to be transmitted via the individual static band unique to the network unit 80-c and the low-priority information to be transmitted via a sharable band which is allotted in addition to the individual static band (hereinafter called an ‘individual shared band’) are separately stored in the transmission buffers 82F-c, 82C-c respectively.

The buffer reading part 83-c reads the low-priority information, out of the low-priority information stored in the transmission buffer 82C-c, which is extracted by the polling-information extracting part 81-c and is to be transmitted via the individual shared band allotted to a local station thereof, and furthermore, reads from the transmission buffer 82F-c the high-priority information to be transmitted via the aforesaid individual static band.

During a period (the time slot) which is determined under the control of the line terminating equipment 50 and appropriate for a predetermined transmission system, the upstream multiplexing part 86-c transmits in sequence a combination of these read-out low-priority information and high-priority information (hereinafter called an ‘upstream transmission information’) to the line terminating equipment 50 via the optical transmission path 71-U as a cell (or an array of cells) appropriate for the transmission system.

The buffer-length determining part 84-c obtains information content of the low-priority information accumulated in the transmission buffer 82C-c at a predetermined frequency (here, supposed to be given as the fixed cycle T for simplicity) and gives this information content to the polling-request generating part 85-c.

The polling-request generating part 85-c generates a ‘polling request’ including this information content and sends out the ‘polling request’ to the line terminating equipment 50 via the upstream multiplexing part 86-c and the optical transmission path 71-U (FIG. 12 (1)).

Incidentally, since a form of a cell which indicates the ‘polling request’ and a communication protocol to be applied in a process of transmission of the ‘polling request’ to the line terminating equipment 50 are not characteristics of the present invention and are realizable under the application of various known technologies, the explanations thereof are omitted here.

Meanwhile, in the line terminating equipment 50, the polling-request extracting part 59 discriminates the ‘upstream transmission information’ and the ‘polling request’ received via the optical transmission path 71-U, based on a difference in forms of their cells, and stores, as the aforesaid information content in a buffer C_{B}, the ‘polling request’ in a predetermined storage area corresponding to the network unit 80-c which is a transmitting end of the ‘polling request’, out of the storage areas of the individual information table 51.

The controlling part 54 processes the following (FIG. 12 (2)) at a cycle equal to or more often than a cycle for receiving the aforesaid ‘polling request’ (hereinafter called a ‘bandwidth-update cycle’).

to perform an arithmetic operation expressed by the following recursion formula with respect to a transmission band b_{c(n-1)} which the controlling part 54 precedingly allots to each of the network unit 80-c (c=1 to N) in an order of a time sequence n at the bandwidth-update cycle and with respect to the aforesaid coefficients α, β stored as office data in the sharable information table 52 in advance, so that record-depending bandwidth H_{cn} (FIG. 13(a)) corresponding to a weighted average of the transmission band b_{c(n-1)} and a transmission bandwidth appropriate for information content of transmission information to be transmitted constantly from the network unit 80-c is computed.

H_{cn}=(α·b_{c(n-1)}+β·H_{c(n-1)})/(α+β) (1)

to compute a deficient bandwidth Bₚwhich is given by the following formula with respect to the aggregate bandwidth Bₐ, a number of bandwidth-update slots S stored in the sharable information table 52 in advance, and the information content in a buffer C_{B} stored in the individual information table 51 correspondingly to the network unit 80-c, and which is given as one with a smaller value between a deficiency of the transmission band precedingly allotted to the network unit 80-c and a bandwidth allowed to be allotted to the network unit 80-c, out of the sharable band.

Bₚ=C_{B}·Bₐ/S (2)

to compute a sum total ΣB_{P} of the updated deficient bandwidths which are computed for all the network units 80-1 to 80-N (hereinafter called a ‘total deficient bandwidth’).

to compute a ratio x of the sum total ΣB_{P} to the aforesaid ‘upper limit of total-sharable-bandwidth which is stored in the sharable information table 52 (FIG. 13) and judge whether or not a value for the ratio x exceeds ‘1’.

to distribute a persistent transmission band proportionally in a ratio of the record-depending bandwidth H_{cn}, (c=1 to N) to a sum total thereof to determine the individual shared bandwidth to be allotted to the network unit 80-c (c=1 to N) in addition to the individual static bandwidth B_{cf} when a result of the judgment is false.

on the contrary, when the result of the judgment is true, to determine the individual shared bandwidth to be allotted to each of the network units 80-1 to 80-N in a fair manner according to the ratio x while securing a minimum transmission bandwidth to be allotted to each of the network units 80-1 to 80-N as the individual shared bandwidth, for example, as shown by the solid line in FIG. 13.

The polling-message generating part 53C generates a message indicating a value for the individual shared bandwidth, which is determined by the controlling part 54 as described above, corresponding to the network unit 80-c (c=1 to N) (hereinafter called a ‘sharable-band polling message’). The polling buffer 55C stores the ‘sharable-band polling message’ correspondingly to each of the network units which is to be its destination.

Furthermore, the polling-message generating part 53F generates a message indicating the individual static bandwidth B_{cf} to be allotted to the network unit 80-c (c=1 to N) (hereinafter called a ‘static-band polling message’). The polling buffer 55F stores the ‘static-band polling message’ correspondingly to each of the network unit which is to be its destination.

The polling-message multiplexing part 57 reads a combination of the ‘static-band polling message’ and the ‘sharable-band polling message’ to be notified to each of the network units 80-1 to 80-N out of the ‘static-band polling messages’ and the ‘sharable-band polling messages’ stored in the polling buffers 55F, 55C respectively, when necessary, and gives the combination to the downstream multiplexing part 58.

The downstream multiplexing part 58 converts the combination of the ‘static-band polling message’ and the ‘sharable-band polling message’, which are given thereto in this way, and/or downstream transmission information to be transmitted to the destination of the combination into a predetermined cell and at the same time transmits the cell to the optical transmission path 71-D in sequence based on a prescribed transmission system and communication protocol.

In other words, as the information content of the low-priority information which is stored in the transmission buffers 82C-1 to 82C-N provided individually in the network units 80-1 to 80-N is larger, larger transmission bandwidth is allotted together with the static bandwidth to the network units 80-1 to 80-N within a range in which fairness is secured.

Therefore, the transmission bandwidth of the optical transmission path 71-U is allotted fairly and effectively to the network units 80-1 to 80-N without giving too large a transmission bandwidth to any of the network units 80-1 to 80-N so that equal service quality is realized.

Incidentally, the above conventional example corresponds to a background art related to the present invention among technologies disclosed in the application Japanese Unexamined Patent Application Publication No. Hei 12-60244) which is previously applied by the same applicant of the present application.

In the conventional example described above, for example, when a large amount of the low-priority information occurs in a short period in the network unit 80-c or the individual shared bandwidth which is precedingly allotted to the network unit 80-c does not necessarily have a sufficiently large value, a large amount of the low-priority information may possibly be accumulated in the transmission buffer 82C-c.

In this case, when a large amount of the sharable bandwidth is allotted under the control of the line terminating equipment 50 (FIG. 14 (1)), the transmission of the low-priority information which is accumulated in the transmission buffer 82C-c is promptly finished in the corresponding network unit 80-c (FIG. 14 (2)) and a phenomenon that drastic decrease in the individual shared bandwidth allotted to this network unit 80-c (FIG. 14 (3)) synchronizes with the transmission completion occurs (hereinafter called an ‘allotted bandwidth vibration’).

The allotted bandwidth vibration also occurs almost at the same time in a different network unit (FIG. 14 (4)), out of the network units 80-1 to 80-N, in which no low-priority information is accumulated in the transmission buffer thereof or the information content of the low-priority information accumulated in the transmission buffer is small and is almost fixed, because the sharable bandwidth which can be allotted as the individual shared bandwidth is limited, so that unevenness in transmission efficiency and service quality is often caused.

### SUMMARY OF THE INVENTION

It is an object of the preset invention to provide a line terminating equipment which is capable of allotting a sharable bandwidth appropriately and stably to individual terminals without making substantial change in hardware structure thereof.

It is another object of the present invention to maintain a transmission bandwidth to be subsequently allotted for any terminal without sharp, substantial decrease when transmission information which was precedingly accumulated and has not been completely transmitted is mostly transmitted and content of the transmission information actually and precedingly received from the terminal is large.

It is still another object of the present invention to enhance precision of a transmission bandwidth to be allotted to each terminal since untransmitted information content and receipt information content are obtained with high precision according to transmission information which is transmitted via a transmission bandwidth other than the allotted transmission bandwidth, even when some transmission bandwidth is constantly allotted to the terminal. (Here, “a transmission bandwidth other than the allotted transmission bandwidth” signifies that the both bandwidths do not contain the common band. And also, in the following similar descriptions should be understood that there is no common band in two bandwidths irrespective of type of the bandwidths.)

It is yet another object of the present invention to determine a deficient bandwidth at a larger value for any terminal as receipt information content is larger, and to promptly allot a transmission bandwidth necessary to transmit transmission information even when the transmission information to be transmitted to a transmission channel increases drastically.

It is yet another object of the present invention to realize load reduction and improvement in responsiveness since a transmission bandwidth to be allotted to any terminal is computed based on a far simpler arithmetic operation than a complicated operation which is expressed as a recursion formula and so on.

It is yet another object of the present invention to realize flexible adaptation to requests for maintenance and operation.

It is yet another object of the present invention to shorten a transmission delay for any terminal which may possibly occur due to an insufficient deficient bandwidth since the deficient bandwidth has a large value during a period in which untransmitted information content is increasing so that, even when the untransmitted information content increases drastically, transmission bandwidth necessary to transmit accumulated information is smoothly secured.

It is yet another object of the present invention to effectively allot to all terminals a transmission bandwidth of a transmission channel, without any available transmission bandwidth uselessly left unallotted.

It is yet another object of the present invention to stably allot to any terminal a transmission bandwidth to be given as a contracted bandwidth regardless of values of untransmitted information content and receipt information content.

It is yet another object of the present invention to prevent, even when any plural terminals almost simultaneously have no transmission information to be transmitted, transmission bandwidths to be allotted as record-depending bandwidths to these terminals from being set at unnecessarily small values, as long as the aforesaid prescribed bandwidths have proper values.

It is yet another object of the present invention to allot an appropriate transmission bandwidth with high precision to any terminal regardless of values of untransmitted information content and receipt information content.

It is yet another object of the present invention to simplify arithmetic operations necessary for computing a requisite bandwidth and a record-depending bandwidth and to realize load reduction and improvement in responsiveness for any terminal.

It is yet another object of the present invention to realize structure simplification and scale reduction and enhance responsiveness and reliability since receipt information content and untransmitted information content are computed as values which can be considered to be integers under a predetermined scaling and all of a requisite bandwidth, a record-depending bandwidth, and a deficient bandwidth are obtained by an integer arithmetic or a fixed-point arithmetic according to these values.

It is yet another object of the present invention to allot a transmission bandwidth of a transmission channel flexibly, effectively, and efficiently to all terminals and enhance total reliability as well as service quality and transmission quality without drastically changing the structure of a communication system to which the invention is applied, compared to in a conventional example.

The above objects are achieved by a line terminating equipment where a requisite bandwidth of each terminal is computed as an increasing function of receipt information content which is information content of transmission information precedingly received from the terminal and untransmitted information content which is notified by the terminal, and a transmission bandwidth to be allotted to each of the terminals is determined in a manner which is decided according to a comparison result of magnitude between a sum total of the requisite bandwidths and the transmission bandwidth of a transmission channel.

In this line terminating equipment, the sum total of the requisite bandwidths to be allotted to the individual terminals becomes larger as one of the untransmitted information content individually notified and the receipt information content which is the content of the transmission information actually and precedingly received increases.

The above objects are also achieved by a line terminating equipment which is characterized in that a known transmission bandwidth is allotted constantly to each of a part or all of terminals, untransmitted information content is notified as content of transmission information to be transmitted via a transmission bandwidth other than the known transmission bandwidth, and receipt information content is measured as content of transmission information which is received via the transmission bandwidth other than the known transmission bandwidth, and furthermore, a transmission bandwidth to be allotted to each of the terminals is a transmission bandwidth other than the known transmission bandwidth.

In this line terminating equipment, even when some transmission bandwidth is constantly allotted to each of the terminals, the untransmitted information content and the receipt information content are obtained with high precision according to the transmission information which is transmitted via the transmission bandwidth other than the known transmission bandwidth so that precision of the transmission bandwidth to be allotted to the terminals is enhanced.

The above objects are also achieved by a line terminating equipment which is characterized in that a requisite bandwidth is computed as an increasing function having increasing rates for receipt information content and untransmitted information content and suitable for an event and/or a state identified in a process of communication control.

In this line terminating equipment, a deficient bandwidth has a larger value as receipt information content increases, and therefore, even when transmission information to be transmitted to a transmission channel increases drastically, a transmission bandwidth necessary to transmit this transmission information is promptly allotted to any of terminals.

The above objects are also achieved by a line terminating equipment which is characterized in that a deficient bandwidth is computed and employed as an increasing function of untransmitted information content and receipt information content.

In this line terminating equipment, the deficient bandwidth has a larger value as receipt information content increases, and therefore, even when transmission information to be transmitted to a transmission channel increases drastically, a transmission bandwidth necessary to transmit this transmission information is promptly allotted to any of terminals.

The above objects are also achieved by a line terminating equipment where a deficient bandwidth is computed and employed as a monotone nondecreasing function of untransmitted information content.

In this line terminating equipment, the deficient bandwidth has a large value during a period when the untransmitted information content is increasing, and therefore, even when the untransmitted information content increases drastically, a transmission bandwidth necessary to transmit accumulated information is smoothly secured for any of terminals so that transmission delay which may possibly occur due to an insufficient deficient bandwidth is shortened.

The above objects are also achieved by a line terminating equipment which is characterized in that a requisite bandwidth for each terminal is computed as an increasing function of receipt information content, which is content of transmission information precedingly received from each terminal, and untransmitted information content, which is notified by each terminal. A transmission bandwidth is allotted to each terminal and is equal to a product of the computed requisite bandwidth and a ratio d of a transmission bandwidth of a transmission channel to a sum of: a product of a sum total of the requisite bandwidths and a coefficient γ(>1); and a sum total of minimum transmission bandwidths to be allotted to the each terminal.

In this line terminating equipment, the transmission bandwidth to be allotted to each of the terminals is computed based on a much simpler arithmetic operation than a complicated operation expressed by a recursion formula and so on, which realizes load reduction and improvement in responsiveness.

The above objects are also achieved by a line terminating equipment which is characterized in that a known transmission bandwidth is allotted constantly to each of a part or all of the terminals, untransmitted information content is notified as information content of transmission information to be transmitted via a transmission bandwidth other than the known transmission bandwidth, and receipt information content is measured as information content of transmission information which is received via the transmission bandwidth other than the known transmission bandwidth, and furthermore, a transmission bandwidth to be allotted to each of the terminals is a transmission bandwidth other than the known transmission bandwidth.

In this line terminating equipment, even when some transmission bandwidth is constantly allotted to individual terminals, the untransmitted information content and the receipt information content are obtained with high precision according to transmission information which is transmitted via the transmission bandwidth other than the allotted transmission bandwidth.

The above objects are also achieved by a line terminating equipment which is characterized in that a requisite bandwidth is computed as an increasing function having increasing rates for receipt information content and untransmitted information content and suitable for an event and/or a state identified in a process of communication control.

In this line terminating equipment, it is possible to realize flexible adaptation to requests for maintenance and operation as well as improvement in service quality and reliability, and cost reduction, compared with a case in which the increasing function is not updated in accordance with an event and a state which are identified in the process of the communication control.

The above objects are also achieved by a line terminating equipment which is characterized in that a sum total of surplus transmission bandwidths which are left unallotted to any of terminals due to attribute and operation precision of an algorithm, is monitored, and the surplus transmission bandwidth is allotted in the proportion of a prescribed bandwidth set in advance or given for each of the terminals to the entire prescribed bandwidth.

In this line terminating equipment, all of the transmission bandwidths of a transmission channel which can be allotted to the individual terminals is effectively allotted to the terminals with no transmission bandwidth left uselessly unallotted.

The above objects are also achieved by a line terminating equipment which is characterized in that a minimum transmission bandwidth to be allotted to each terminal is stably given as a contracted bandwidth of the terminal.

In this line terminating equipment, the transmission bandwidth given as the contracted bandwidth is stably allotted to any of the terminals regardless of values of untransmitted information content and receipt information content.

The above objects are also achieved by a line terminating equipment which is characterized in that a record-depending bandwidth is computed for each terminal as an increasing function whose value is equal to a prescribed bandwidth set in advance or given, when receipt information content and untransmitted information content are ‘0’.

In this line terminating equipment, even when any plural terminals almost simultaneously have no transmission information to be transmitted, transmission bandwidths to be allotted to the terminals as record-depending bandwidths are not set at unnecessarily small values as long as the aforesaid prescribed bandwidths have proper values.

The above objects are also achieved by a line terminating equipment which is characterized in that an increasing function by which a requisite bandwidth is obtained and/or an increasing function by which a record-depending bandwidth is obtained is/are increasing function(s) where errors in the requisite bandwidth and the record-depending bandwidth are permissibly small.

In this line terminating equipment, a proper transmission bandwidth is allotted with high precision to any of terminals regardless of values for untransmitted information content and receipt information content.

The above objects are also achieved by a line terminating equipment which is characterized in that an increasing function by which a requisite bandwidth is obtained and/or an increasing function by which a record-depending bandwidth is obtained is/are approximate function(s) where errors in the requisite bandwidth and the record-depending bandwidth are permissibly small.

In this line terminating equipment, it is possible to simplify arithmetic operations necessary for computing the requisite bandwidth and the record-depending bandwidth and to realize load reduction and improvement in responsiveness for any terminal.

The above objects are also achieved by a line terminating equipment which is characterized in that transmission information is received from each of terminals as a sequence of transmission units whose word lengths are fixed or can be considered to be fixed, and receipt information content, untransmitted information content, a requisite bandwidth, a record-depending bandwidth, and all the transmission bandwidths are given as a ratio of the transmission bandwidth of a transmission channel to the word lengths or an average of the word lengths.

In this line terminating equipment, the receipt information content and the untransmitted information content are computed as values which can be considered as integers under a predetermined scaling, and all of the requisite bandwidth, the record-depending bandwidth, and the deficient bandwidth are obtained by an integer arithmetic or a fixed-point arithmetic performed for these values.

This enables structure simplification, scale reduction, and improvement in responsiveness and reliability.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a block diagram of a first principle of the present invention;

FIG. 2 is a block diagram of a second principle of the present invention;

FIG. 3 is a diagram showing first to fifth embodiments of the present invention;

FIG. 4 is a flow chart of operations in the first and second embodiments of the present invention;

FIG. 5 is a chart showing a sharable bandwidth allotted to a network unit in this embodiment;

FIG. 6 is a flow chart of operations in a third embodiment of the present invention;

FIG. 7 is a flow chart of operations in a fourth embodiment of the present invention;

FIG. 8 is a flow chart of operations in a fifth embodiment of the present invention;

FIG. 9 is a diagram showing a structure example of a polling request transmitted as divided slots;

FIG. 10 is a diagram showing a structure example of an ATM-PON system;

FIG. 11 is a chart showing an example of transmission bandwidths allotted to individual network units in a conventional example;

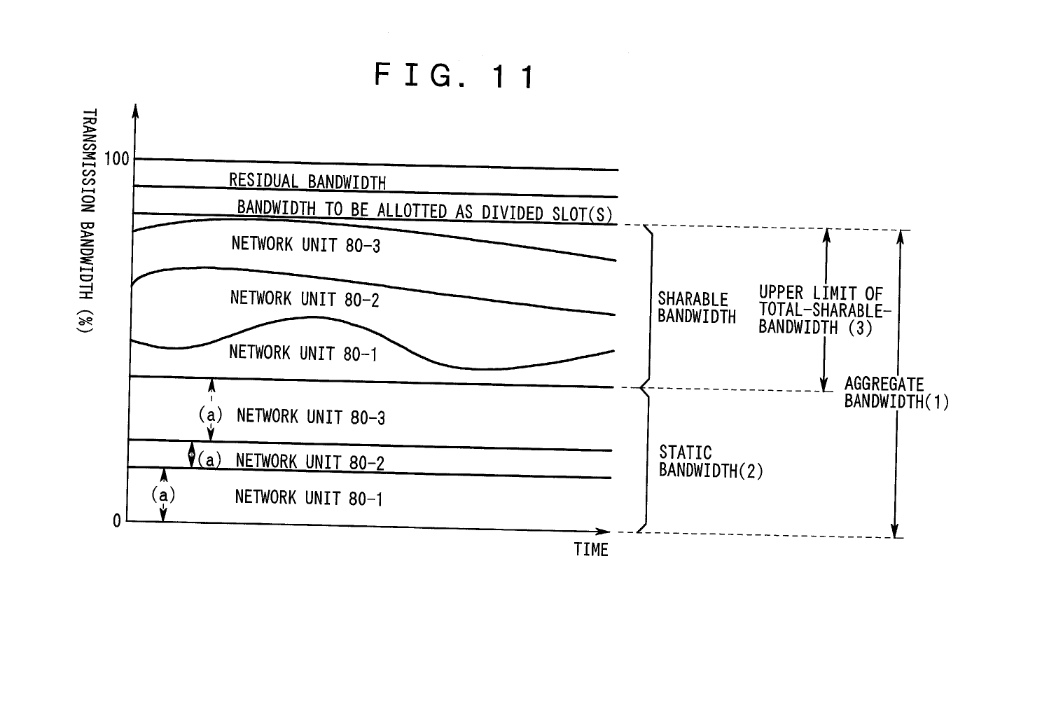

FIG. 12 is a chart explaining an operation in the conventional example;

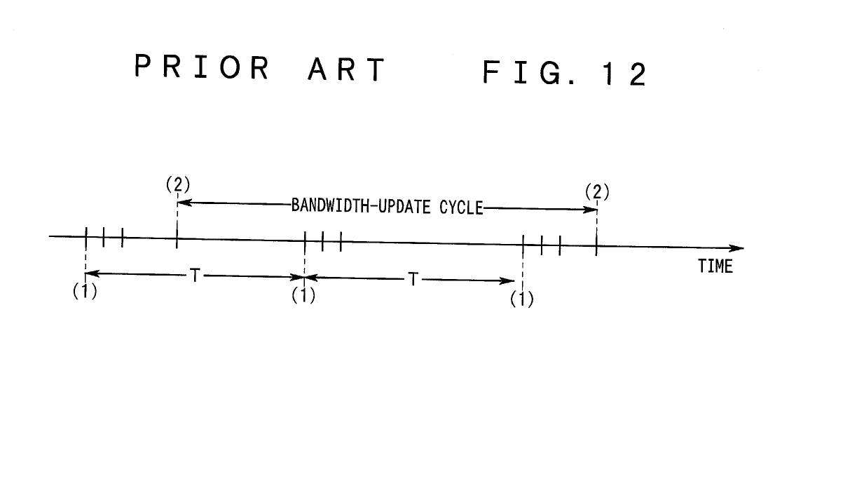

FIG. 13 is a chart showing content of a transmission bandwidth allotted to each of the network units, out of a sharable bandwidth; and

FIG. 14 is a chart showing a problem to be solved in the conventional example.

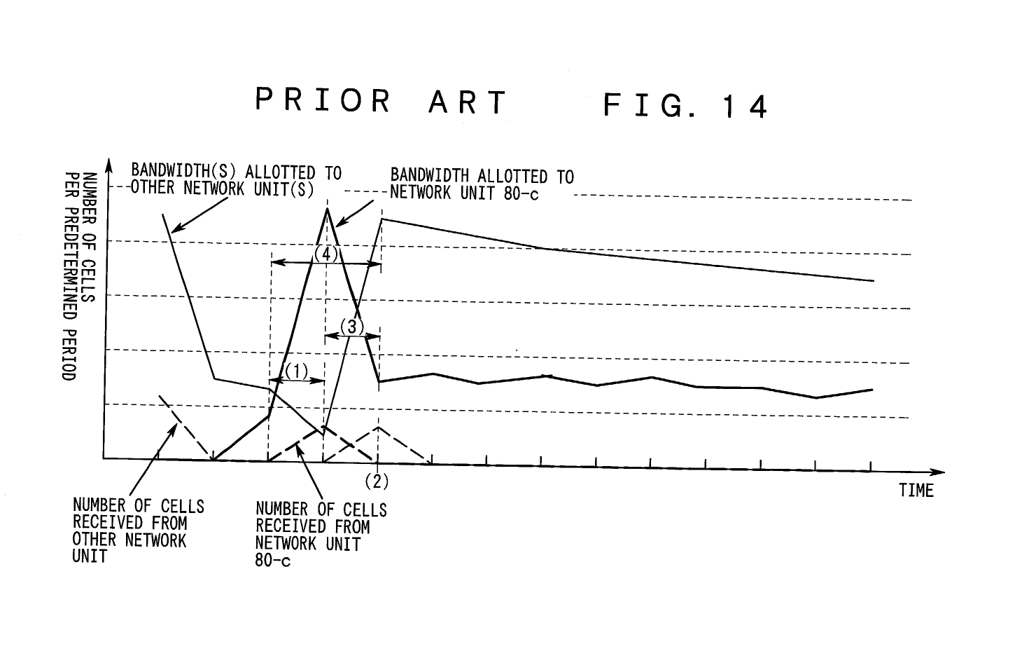

### DESCRIPTION OF THE PREFERRED EMBODIMENTS

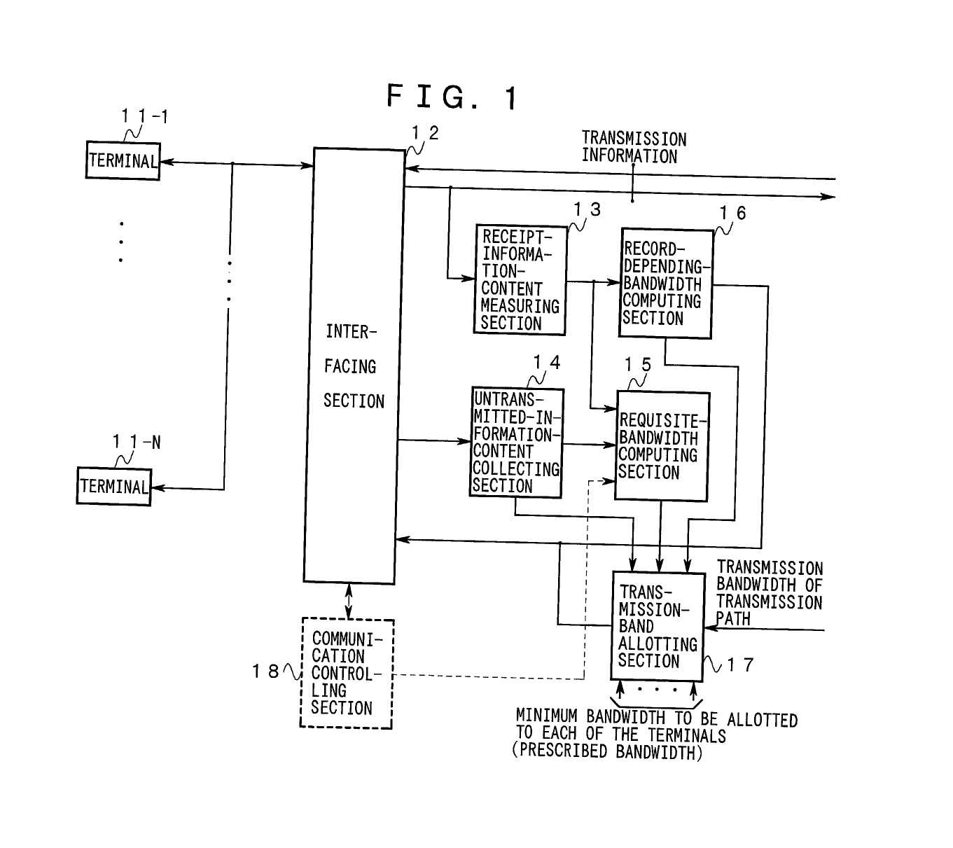

Principles of a line terminating equipment according to the present invention are first explained with reference to FIG. 1.

FIG. 1 is a block diagram showing a first principle of the present invention.

The line terminating equipment shown in FIG. 1 is composed of an interfacing section 12 connected to terminals 11-1 to 11-N, a receipt information content measuring section 13, an untransmitted-information-content collecting section 14, a requisite-bandwidth computing section 16, a record-depending-bandwidth computing section 16, a transmission-band allotting section 17, and a communication controlling section 18.

A principle of a first line terminating equipment according to the present invention is described as follows.

The interfacing section 12 interfaces with a transmission channel formed in common between the interfacing section 12 and the plural terminals 11-1 to 11-N. The receipt-information-content measuring section 13 measures receipt information content which is information content of transmission information received from the plural terminals 11-1 to 11-N. The untransmitted-information-content collecting section 14 collects untransmitted information content which is information content of transmission information notified by the plural terminals 11-1 to 11-N, accumulated in the terminals 11-1 to 11-N, and has not been completely transmitted. For each of the plural terminals 11-1 to 11-N, the requisite-bandwidth computing section 15 computes, as an increasing function of the receipt information content measured by the receipt-information-content measuring section 13 and the untransmitted information content collected by the untransmitted-information-content collecting section 14, a requisite bandwidth which is a transmission bandwidth necessary to be allotted out of a transmission bandwidth of the transmission channel. For each of the plural terminals 11-1 to 11-N, the record-depending-bandwidth computing section 16 computes, as an increasing function of the transmission bandwidth which is precedingly allotted and the receipt information content which is measured by the receipt-information-content measuring section 13, a record-depending bandwidth to be further allotted out of the transmission bandwidth of the transmission channel. To each of the plural terminals 11-1 to 11-N via the interfacing section 12 and the transmission channel, the transmission-band allotting section 17 allots, out of the transmission bandwidth of the transmission channel, a sum of a deficient bandwidth given as an increasing function of the untransmitted information content, which is collected by the untransmitted-information-content collecting section 14, and a bandwidth obtained by distributing a surplus bandwidth other than the deficient bandwidth proportionally in the proportion of the record-depending bandwidth to the entire record-depending bandwidth, which is computed by the record-depending bandwidth computing section 16, when a sum total of the requisite bandwidths which are computed by the requisite-bandwidth computing section 15 is smaller than the transmission bandwidth of the transmission channel.

On the contrary, when the sum total of the requisite bandwidths computed by the requisite-bandwidth computing section 15 exceeds the transmission bandwidth of the transmission channel, the transmission-band allotting section 17 allots a sum of a minimum transmission bandwidth to be allotted to each of the plural terminals 11-1 to 11-N and a bandwidth obtained by distributing a surplus bandwidth other than the minimum transmission bandwidth proportionally in the proportion of the record-depending bandwidth to the entire record-depending bandwidth.

Therefore, the sum total of the requisite bandwidths being subject of the above judgment necessary to be allotted to the terminals 11-1 to 11-N are determined at a larger value as one of the untransmitted information content notified by each of the terminals 11-1 to 11-N and the receipt information content which is the information content of the transmission information actually and precedingly received increases.

Consequently, even when the transmission information which was precedingly accumulated in one of the terminals 11-1 to 11-N and has not been completely transmitted is mostly transmitted, a transmission bandwidth to be allotted subsequently is maintained without decreasing abruptly or greatly as the information content of the transmission information which is actually and precedingly received from the corresponding terminal is larger.

A principle of a second line terminating equipment according to the present invention is described as follows.

In the second line terminating equipment according to the present invention, a known transmission bandwidth out of the transmission bandwidth of the transmission channel is constantly allotted to a part or all of the plural terminals 11-1 to 11-N. The untransmitted information content notified by each of the plural terminals 11-1 to 11-N is given as content of transmission information to be transmitted via a transmission bandwidth other than the known transmission bandwidth, out of the transmission information which was accumulated in each of the terminals 11-1 to 11-N and has not been completely transmitted. The receipt-information-content measuring section 13 measures, as the receipt information content, content of transmission information received via the transmission bandwidth other than the known transmission bandwidth, out of the transmission information received from each of the plural terminals 11-1 to 11-N. The record-depending-bandwidth computing section 16 employs the transmission bandwidth other than the known transmission bandwidth as the transmission bandwidth precedingly allotted.

In other words, even when some transmission bandwidth is constantly allotted to the terminals 11-1 to 11-N, the untransmitted information content and the receipt information content are obtained with high precision according to the transmission information which is transmitted via the transmission bandwidth other than the known transmission bandwidth so that precision of the transmission bandwidth to be allotted to each of the terminals 11-1 to 11-N is enhanced.

A principle of a third line terminating equipment according to the present invention is described as follows.

In the third line terminating equipment according to the present invention, the transmission-band allotting section 17, computes and employs the deficient bandwidth given as the increasing function of both of the untransmitted information content, which is collected by the untransmitted-information-content collecting section 14, and the receipt information content, which is measured by the receipt-information-content measuring section 13.

In other words, the deficient bandwidth is determined at a larger value for any of the terminals 11-1 to 11-N as the receipt information content is larger, and consequently, even when transmission information to be transmitted to the transmission channel increases drastically, a transmission bandwidth necessary for transmitting this transmission information is promptly allotted.

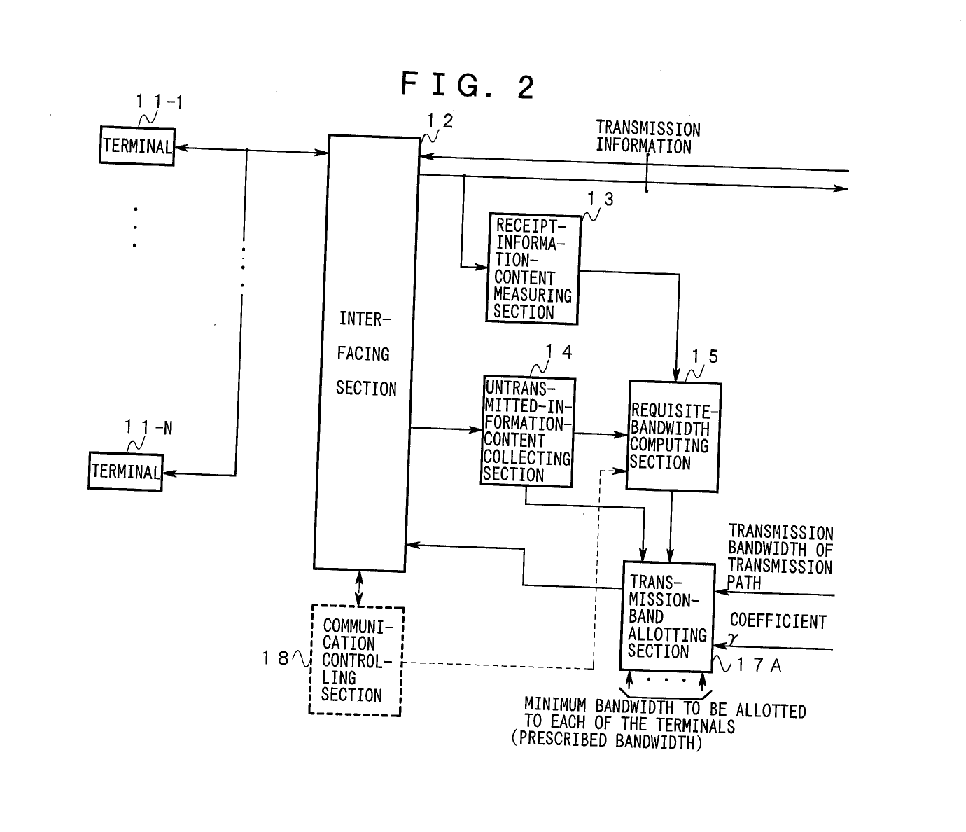

FIG. 2 is a block diagram of a second principle of the present invention.

The line terminating equipment shown in FIG. 2 is composed of the interfacing section 12 connected to the terminals 11-1 to 11-N, the receipt-information-content measuring section 13, the untransmitted-information-content collecting section 14, the requisite-bandwidth computing section 15, a transmission-band allotting section 17A, and the communication controlling section 18.

A principle of a fourth line terminating equipment according to the present invention is described as follows.

The interfacing section 12 interfaces with the transmission channel formed in common between the interfacing section 12 and the plural terminals 11-1 to 11-N. The receipt-information-content measuring section 13 measures the receipt information content which is the information content of the transmission information received from the plural terminals 11-1 to 11-N. The untransmitted-information-content collecting section 14 collects the untransmitted information content which is the information content of the transmission information notified by the plural terminals 11-1 to 11-N, accumulated in the terminals 11-1 to 11-N, and not completely transmitted. For each of the plural terminals 11-1 to 11-N, the requisite-bandwidth computing section 15 computes, as the increasing function of the receipt information content measured by the receipt-information-content measuring section 13 and the untransmitted information content collected by the untransmitted-information-content collecting section 14, the requisite bandwidth which is the transmission bandwidth necessary to be allotted, out of the transmission bandwidth of the transmission channel.

The transmission-band allotting section 17A computes a transmission bandwidth which is equal to a product of the requisite bandwidth, which is computed by the requisite-transmission-band computing section 15, and a ratio d of the transmission bandwidth of the transmission channel relative to a sum of: a product of the sum total of the requisite bandwidths and a coefficient γ(>1); and the sum total of the minimum transmission bandwidths to be allotted to the individual terminals, and it allots the transmission bandwidth to each of the terminals 11-1 to 11-N via the interfacing section 12 and the transmission channel.

In other words, the transmission bandwidth to be allotted to each of the terminals 11-1 to 11-N is also computed based on a far simpler arithmetic operation than a complicated operation which is expressed by a recursion formula and so on so that load reduction and improvement in responsiveness are realized.

A principle of a fifth line terminating equipment according to the present invention is described as follows.

The known transmission bandwidth out of the transmission bandwidth of the transmission channel is constantly allotted to each of a part or all of the plural terminals 11-1 to 11-N. The untransmitted information content which is notified by each of the plural terminals 11-1 to 11-N is given as the information content of the transmission information to be transmitted via the transmission bandwidth other than the known transmission bandwidth, out of the transmission information which was accumulated in each of the terminals 11-1 to 11-N and has not been completely transmitted. The receipt-information-content measuring section 13 measures, as the receipt information content, the information content of the transmission information received via the transmission bandwidth other than the known transmission bandwidth, out of the transmission information received from each of the plural terminals 11-1 to 11-N.

In other words, even when some transmission bandwidth is constantly allotted to the terminals 11-1 to 11-N, the untransmitted information content and the receipt information content are obtained with high precision according to the transmission information which is transmitted via the transmission bandwidth other than the allotted transmission bandwidth so that precision of the transmission bandwidth to be allotted to each of the terminals is enhanced.

A principle of a sixth line terminating equipment according to the present invention is described as follows.

The communication controlling section 18 performs communication control involving the transmission channel via the interfacing section 12. The requisite-bandwidth computing section 15 computes the requisite bandwidth as an increasing function having increasing rates for the receipt information content measured by the receipt-information-content measuring section 13 and the untransmitted information content collected by the untransmitted-information-content collecting section 14, and suitable for an event and/or a state which is/are identified in a process of the communication control by the communication controlling section 18.

In other words, compared to a case in which the increasing function is never updated regardless of the event and the state which may possibly be identified in the process of the communication control, improvement in service quality and reliability, and cost reduction as well as flexible adaptability to request for maintenance and operation are further realized.

A principle of a seventh line terminating equipment according to the present invention is described as follows.

The transmission-band allotting section 17 computes and employs a deficient bandwidth given as a monotone nondecreasing function of the untransmitted information content which is collected by the untransmitted-information-content collecting section 14.

In other words, transmission delay which may possibly occur due to an insufficient deficient bandwidth is shortened since the deficient bandwidth is determined at a large value during a period in which the untransmitted information content is increasing so that, even when the untransmitted information content increases drastically, transmission bandwidth necessary to transmit accumulated information is smoothly secured for any of the terminals.

A principle of an eighth line terminating equipment according to the present invention is described as follows.

The communication controlling section 18 performs the communication control involving the transmission channel via the interfacing section 12. The requisite-bandwidth computing section 15 computes the requisite bandwidth as the increasing function having the increasing rates for the receipt information content measured by the receipt-information-content measuring section 13 and the untransmitted information content collected by the untransmitted-information-content collecting section 14, and suitable for an event and/or a state which is/are identified in the process of the communication control by the communication controlling section 18.

In other words, compared to the case in which the increasing function is not updated regardless of the event and the state which can be identified in the process of the communication control, improvement in service quality and reliability, and cost reduction as well as flexible adaptability to request for maintenance and operation are further realized.

A principle of a ninth line terminating equipment according to the present invention is described as follows.

Based on a processing procedure for allotting the transmission bandwidth to the plural terminals 11-1 to 11-N, the transmission-band allotting sections 17, 17A monitor a sum total of surplus transmission bandwidths which are left unallotted to any of the terminals due to attribute and operation precision of an algorithm applied to the processing. Furthermore, the transmission-band allotting sections 17, 17A allot the surplus transmission bandwidth in the proportion of a prescribed bandwidth set in advance or given for each of the terminals 11-1 to 11-N to the entire prescribed bandwidth.

In other words, all the transmission bandwidths which can be allotted to the plural terminals 11-1 to 11-N out of the transmission bandwidth of the transmission channel is effectively allotted to the plural terminals 11-1 to 11-N with no transmission bandwidth being persistent uselessly.

A principle of a tenth line terminating equipment according to the present invention is described as follows.

The minimum transmission bandwidth to be allotted to each of the plural terminals 11-1 to 11-N is given as a contracted bandwidth of each of the plural terminals 11-1 to 11-N.

In other words, the transmission bandwidth given as the contracted bandwidth is stably allotted to any of the terminals 11-1 to 11-N regardless of values for the untransmitted information content and the receipt information content.

A principle of an eleventh line terminating equipment according to the present invention is described as follows.

When the receipt information content measured by the receipt-information-content measuring section 13 and the untransmitted information content collected by the untransmitted-information-content collecting section 14 are ‘0’, the record-depending-bandwidth computing section 15 computes the record-depending bandwidth for each of the terminals 11-1 to 11-N as an increasing function whose value is equal to the prescribed bandwidth set in advance or computed for the corresponding terminal.

In other words, even when any plural terminals out of the terminals 11-1 to 11-N almost synchronously have no transmission information to be transmitted, the transmission bandwidths to be allotted to these terminals as the record-depending bandwidth are not set at unnecessarily small values as long as the aforesaid prescribed bandwidths have proper values.

A principle of a twelfth linear line terminating equipment according to the present invention is described as follows.

The increasing function whose value is computed as the requisite bandwidth by the requisite-bandwidth computing section 15 and/or the increasing function whose value is computed as the record-depending bandwidth by the record-depending-bandwidth computing section 16 is/are increasing function(s) where errors in the requisite bandwidth and the record-depending bandwidth for all the terminals 11-1 to 11-N are permissibly small.

Therefore, an appropriate transmission bandwidth is allotted with high precision to any of the terminals 11-1 to 11-N regardless of values for the untransmitted information content and the receipt information content.

A principle of a thirteenth line terminating equipment according to the present invention is described as follows.

The increasing function whose value is computed as the requisite bandwidth by the requisite-bandwidth computing section 15 and/or the increasing function whose value is computed as the record-depending bandwidth by the record-depending-bandwidth computing section 16 is/are approximate function(s) where errors in the requisite bandwidth and the record-depending bandwidth for all the terminals 11-1 to 11-N are permissibly small.

Therefore, arithmetic operations necessary for computing the requisite bandwidth and the record-depending bandwidth are simplified so that load reduction and improvement in responsiveness are realized for any of the terminals 11-1 to 11-N.

A principle of a fourteenth line terminating equipment according to the present invention is described as follows.

The transmission information to be received from the plural terminals 11-1 to 11-N is given as a sequence of transmission units whose word lengths are fixed or can be considered to be fixed. The receipt information content, the untransmitted information content, the requisite bandwidth, the record-depending bandwidth, and all the transmission bandwidths are given as a ratio of the transmission bandwidth of the transmission channel to the word lengths or an average of the word lengths.

In other words, the receipt information content and the untransmitted information content are computed as values which can be considered as integers under a predetermined scaling, and all of the requisite bandwidth, the record-depending bandwidth, and the deficient bandwidth are obtained by the integer arithmetic or the fixed-point arithmetic performed for these values.

Therefore, it is possible to simplify the structure and realize scale reduction and improvement in responsiveness and reliability.

Embodiments of the present invention are detailed below with reference to the drawings.

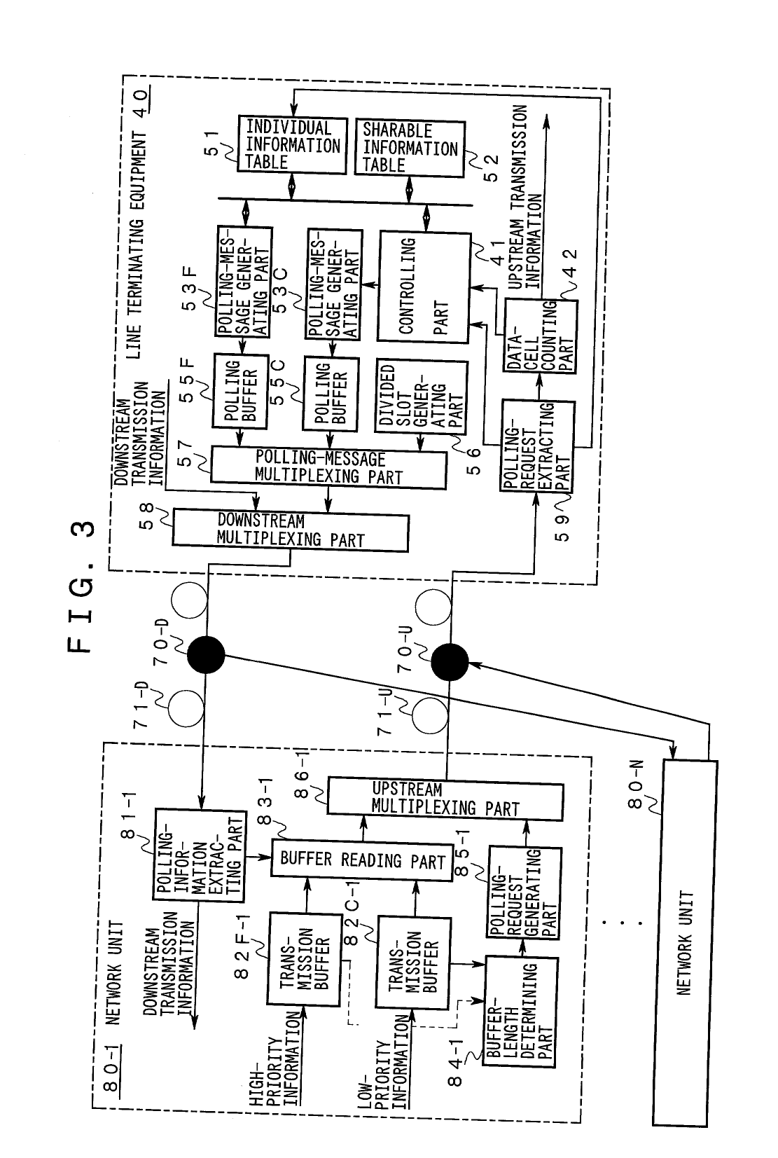

FIG. 3 is a diagram showing first to fifth embodiments of the present invention.

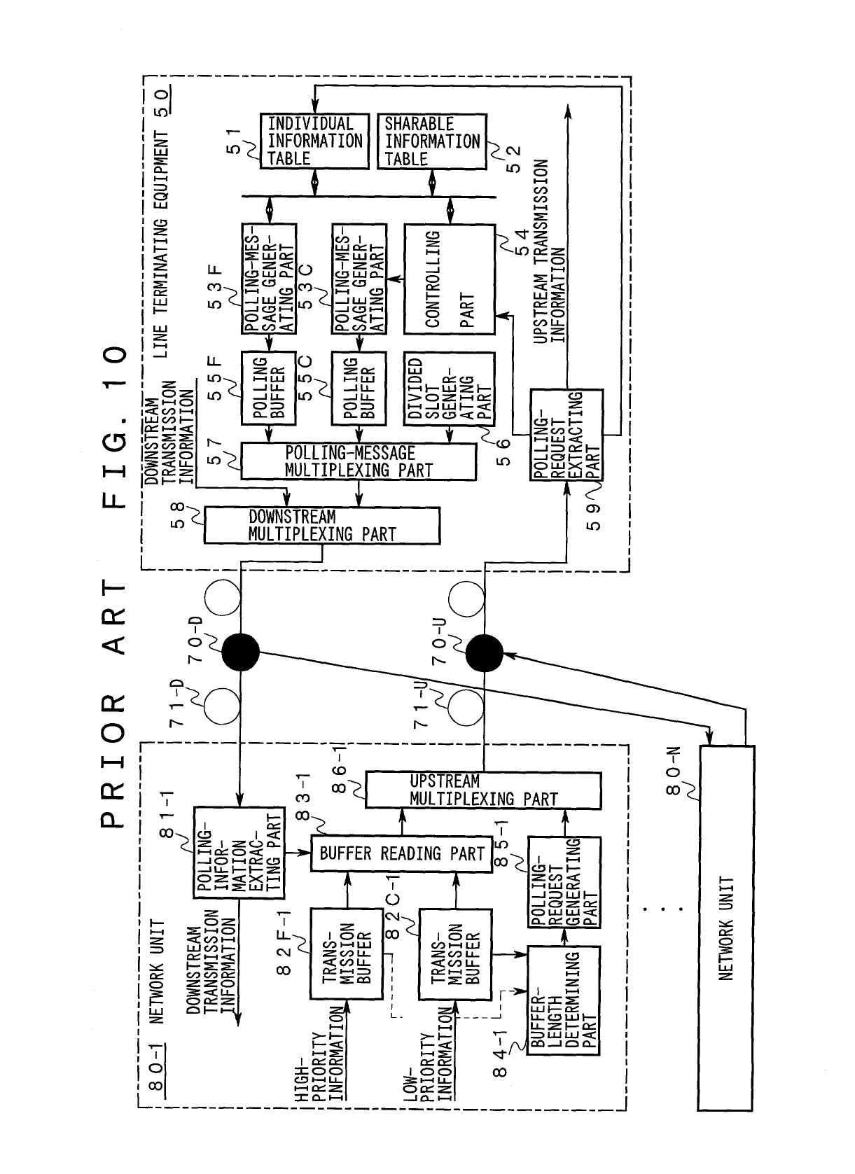

This embodiment is mainly different from the conventional example shown in FIG. 10 in the structure of a line terminating equipment 40 provided in place of the line terminating equipment 50.

The structure of the line terminating equipment 40 is different from that of the line terminating equipment 50 in that a controlling part 41 is provided in place of the controlling part 54 and a data-cell counting part 42 which is disposed on a subsequent stage of the polling-request extracting part 59 and whose output is connected to a specific input port of the controlling part 41 is provided.

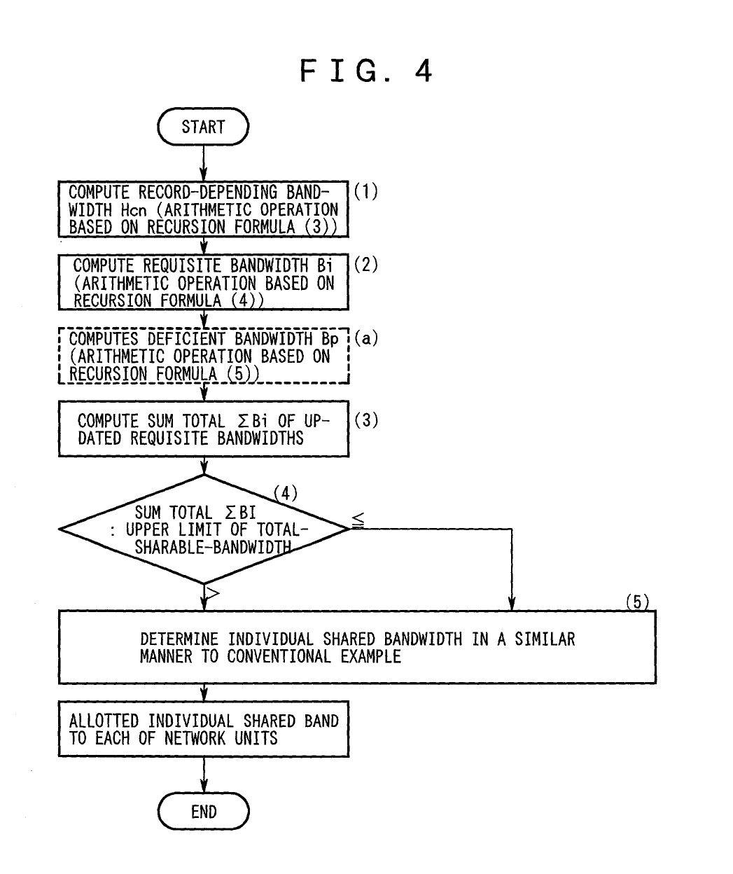

FIG. 4 is a flow chart of operations in the first and second embodiments of the present invention.

The operations in the first embodiment of the present invention are explained below with reference to FIG. 3 and FIG. 4.

This embodiment is characterized by the following processing procedure performed by the controlling part 41 which is provided in the line terminating equipment 40.

Therefore, explanations on operations of each part in the line terminating equipment 40 other than the controlling part 41 are omitted below unless it is necessary.

Furthermore, operations of each part in network units 80-1 to 80-N are the same as in the conventional example, and therefore, the explanations thereof are omitted below.

In a storage area corresponding to each of the network units 80-1 to 80-N out of storage areas of an individual information table 51, a ‘prescribed bandwidth ratio’ r_{B}, which is described later, is stored in advance.

In the line terminating equipment 40, a polling-request extracting part 59 discriminates an ‘upstream transmission information’ and a ‘polling request’ which are received via an optical transmission path 71-U similarly to the conventional example and stores the ‘polling request’ as the aforesaid information content in a buffer C_{B} in a predetermined storage area corresponding to a network unit 80-c which is a transmitting end of the polling request, out of the storage areas of the individual information table 51.

At the same time, the data-cell counting part 42 counts at every cycle T, which is described before, the number of cells (hereinafter called a ‘cell-count’) which are given as the ‘upstream transmission information’ thus discriminated and received individually from the network units 80-1 to 80-N and gives these values to the controlling part 41 as C_{cn} corresponding to the aforesaid time sequence n.

As processing to be performed at the aforesaid bandwidth-update cycle, the controlling part 41 performs processing which is different in the following points from that in the conventional example.

to refer to the aforesaid cell-count C_{c(n-1)} together with the prescribed bandwidth ratio r_{B}, which is stored in the individual information table 51 correspondingly to the network units 80-c (c=1 to N), and perform an arithmetic operation which is expressed by the following recursion formula (3) instead of the aforesaid recursion formula (1) to compute the record-depending bandwidth H_{cn}(FIG. 4 (1))

H_{cn}=(α·C_{c(n-1)}+β·H_{c(n-1)}+r_{B})/(α+β) (3)

to perform an arithmetic operation which is expressed by the following formula with respect to the cell count C_{C} to compute an appropriate requisite bandwidth Bᵢ to be allotted to each of the network units 80-1 to 80-N at this time (FIG. 4 (2))

Bᵢ=(C_{B}+C_{c})·Bₐ/S (4)

to compute a sum total ΣBᵢ of the updated requisite bandwidths which are computed for all the network units 80-1 to 80-N (FIG. 4 (3))

to compute a ratio x of the sum total ΣBᵢ, which substitutes for the sum total ΣB_{P} of updated deficient bandwidths computed in the conventional example, to the aforesaid ‘upper limit of total-sharable-bandwidth which is stored in a sharable information table 52 and judge whether or not the ratio x exceeds ‘1’ (FIG. 4 (4)) and at the same time apply the aforesaid total deficient bandwidth in a similar manner to the conventional example based on the result of the judgment to determine an individual shared bandwidth to be allotted to each of the network units 80-1 to 80-N (FIG. 4 (5))

In other words, the judgment whether or not a sum total of the individual shared bandwidths to be allotted to each of the network units 80-1 to 80-N exceeds the sharable bandwidth which can be actually allotted is made based not only on the information content in a buffer C_{B}, which is notified by each of the network units 80-1 to 80-N, but also on the sum of the information content in a buffer C_{B} and the cell-count C_{C} indicating the information content of the upstream transmission information received individually in a preceding bandwidth-update cycle, as is apparent from a difference between the formula (2) and (4).

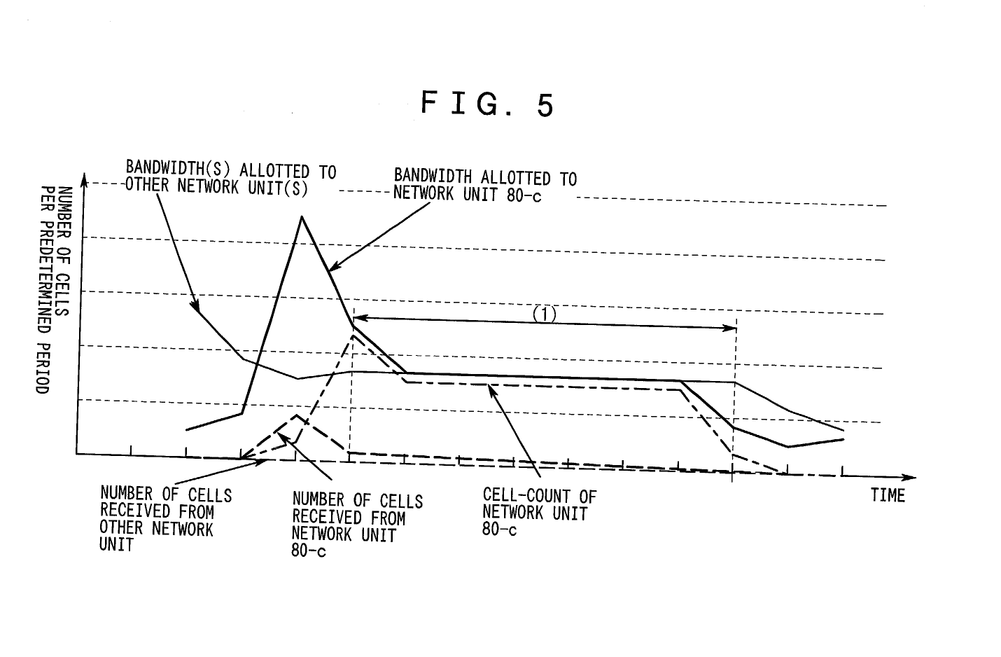

Therefore, according to this embodiment, even after most of the low-priority information accumulated in a transmission buffer is transmitted, the individual shared bandwidth to be allotted subsequently is maintained for any of the network units 80-1 to 80-N without decreasing more abruptly and greatly as the information content of the transmission information precedingly received in the line terminating equipment 40, which is a receiving end of the low-priority information, is larger (FIG. 5 (1)).

According to this embodiment, the record-depending bandwidth H_{cn} to be allotted to the network units 80-1 to 80-N converges on r_{B}/(α+β) even when the cell-count C_{c(n-1)}, which is precedingly computed in the order of the time sequence n for the network units 80-1 to 80-N, and the record-depending bandwidth Hc_{c(n-1)}, which is precedingly obtained, both become ‘0’, as shown in the recursion formula (3).

In other words, even when transmission of most of the low-priority information accumulated in the transmission buffers in the plural network units are finished almost synchronously or these plural network units stop transmitting the transmission information almost synchronously, the bandwidth to be allotted as the record-depending bandwidth in the sharable bandwidth is not unnecessarily set at an excessively small or large value and converges on the contracted bandwidth and other desirable values freely, as long as the prescribed bandwidth ratio r_{B} is set at a proper value in advance (for example, a maximum proportion of the sharable bandwidth to be allotted to the network units 80-1 to 80-N as the record-depending bandwidth).

Therefore, a value for amplitude of an ‘allotted bandwidth vibration’ which occurs in each of the network units or spreads from other network units becomes small so that high transmission quality and service quality are maintained for any of the network units 80-1 to 80-N.

Incidentally, the term r_{B} is included in the numerator of the recursion formula (3) in this embodiment.

However, the term r_{B} needs not be included in the recursion formula (3) when increase in amplitude of the ‘allotted bandwidth vibration’ which may possibly occur in each of the network units or spread from other network units is permissible.

Moreover, in this embodiment, the data-cell counting part 42 computes the sum of both the information content of the high-priority information and the low-priority information which are received from the network units 80-c as the aforesaid cell-count C_{C}.

However, the present invention is not limited to this structure and, for example, when the information content of the high-priority information is so large that an error of cell-count C_{C} is not permissible, the data-cell counting part 42 may discriminates the high-priority information from the low-priority information based on all or a part of a cell form, a communication protocol, a transmission system appropriate for the optical transmission path 71-U and compute only the cell-count of the low-priority information.

In this embodiment, the coefficients α, β which are included in the recursion formula (3) are both fixed values which are set in advance.

However, the present invention is not limited to this structure and, for example, the coefficient α and/or the coefficient β may appropriately be varied according to all or a part of the events and states, as listed below, which are identified based on the communication control procedure.

the cell-count C_{C}

the information content in a buffer C_{B}

traffic distribution in the optical transmission path 71-U and/or the optical transmission path 71-D

an operation condition of the optical transmission path 71-U and/or the optical transmission path 71-D (including a failure)

In this embodiment, the requisite bandwidth Bᵢ is computed by weighing the information content in a buffer C_{B} and the cell-count C_{C} with common weight as shown in the above formula (4).

However, the present invention is not limited to this structure and, for example, the requisite bandwidth Bᵢ may be computed by weighing the information content in a buffer C_{B} and/or the cell-count C_{C} with weight which is updated appropriately according to the above events and states which are identified in the process of the communication control.

In this embodiment, the requisite bandwidth Bᵢ is computed in addition to the deficient bandwidth B_{P.}

However, the present invention is not limited to this structure and, when an error which may possibly occur in the individual shared bandwidth to be allotted to each of the network units 80-1 to 80-N is small enough to be permissible, for example, the requisite bandwidth Bᵢ may be applied instead of the deficient bandwidth B_{P} to simplify the operation.

The second embodiment of the present invention is explained below with reference to FIG. 3.

This embodiment is characterized in that the deficient bandwidth B_{P}, which is computed in the first embodiment in a similar manner to the conventional example, is computed as follows.

For any of the network unit 80-c (c=1 to N), the controlling part 41 accumulates the cell-count C_{C} indicating the number of cells which are given by the data-cell counting part 42 and received from the network unit 80-c at every cycle T, which is mentioned above.

The controlling part 41 also computes the deficient bandwidth B_{P} by performing an arithmetic operation which is expressed by the following formula instead of the aforesaid formula (2) (FIG. 4(a)).

B_{P}=C_{B}·Bₐ/S+K·C_{c} (5)

Note that in the above formula (5), the coefficient K is a coefficient which is applied for converting the cell-count C_{C} to a transmission bandwidth corresponding to the cell-count C_{C}.

Therefore, the transmission bandwidth corresponding to a single cell-count C_{C} which is precedingly obtained is also added as the deficient bandwidth Bₚ to any of the network unit 80-c (c=1 to N), as shown in the above formula (5).

As described above, according to this embodiment, the transmission bandwidth necessary to transmit the transmission information accumulated in a transmission buffer 82C-c or in both of the transmission buffer 82C-c and a transmission buffer 82F-c is stably allotted to any of the network unit 80-c (c=1 to N) so that the ‘allotted bandwidth vibration’ is prevented with high reliability from occurring and spreading to other network units even when a new call occurs or the number of new calls increases suddenly.

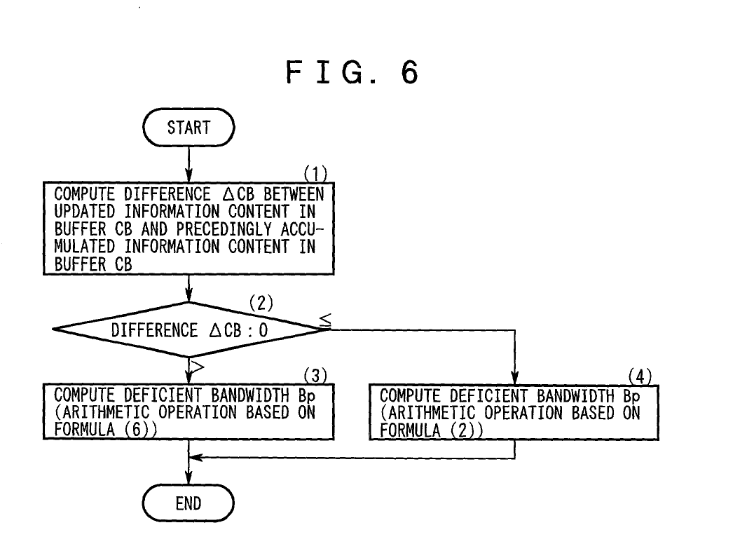

FIG. 6 is a flow chart of operations in the third embodiment of the present invention.

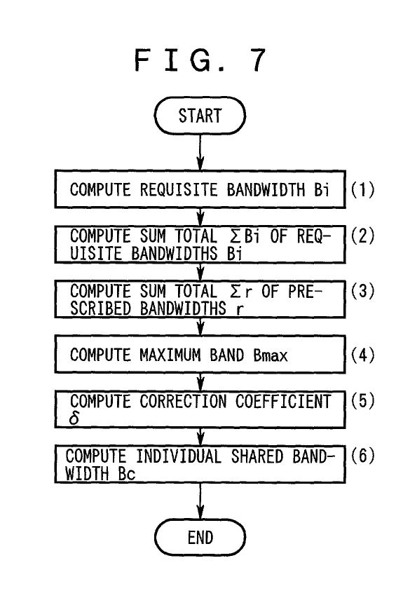

Operations in the third embodiment of the present invention are explained below with reference to FIG. 3 and FIG. 7.

This embodiment is characterized in that the deficient bandwidth B_{P}, which is computed in the first embodiment in a similar manner to the conventional example, is computed as follows.

The controlling part 41 accumulates in sequence the information content in a buffer C_{B} which is individually notified and processes the following for any of the network unit 80-c (c=1 to N).

to compute a difference ΔC_{B} between updated information content in a buffer C_{B} and the information content in a buffer which is precedingly accumulated (FIG. 6 (1))

to judge whether or not the difference ΔC_{B} is a positive number (FIG. 6 (2))

to perform an arithmetic operation which is expressed by the following formula instead of the aforesaid formula (2) to compute the deficient bandwidth B_{P} when the result of the judgment is true (FIG. 6 (3))

B_{P}=C_{B}·Bₐ/S+ΔC_{B} (6)

to perform the arithmetic operation which is expressed by the same formula (2) as in the first embodiment to compute the deficient bandwidth B_{P} when the result of the judgment is false (FIG. 6 (4))

In other words, as shown in the above formula (6), the deficient bandwidth Bₚ is set at a larger value than that computed by the formula (2) within a period in which the information content in a buffer C_{B} increases.

Therefore, according to this embodiment, the transmission of the transmission information accumulated in the transmission buffer 82C-c or both of the transmission buffer 82C-c and the transmission buffer 82F-c is started smoothly and at a high rate and transmission delay is shortened even when a new call occurs or the number of new calls increases suddenly.

FIG. 7 is a flow chart showing operations in the fourth embodiment of the present invention.

The operations in the fourth embodiment of the present invention are explained below with reference to FIG. 3 and FIG. 7.

This embodiment is characterized in that the controlling part 41 computes the individual shared bandwidth to be allotted to each of the network units 80-1 to 80-N based on the following procedure.

In the individual information table 51, the prescribed bandwidth r which is individually given to the network unit 80-c (c=1 to N) in advance is stored.

Meanwhile, in the sharable information table 52, the preset constant 7 (>1) is stored in advance.

The controlling part 41 computes the following values based on the same procedure as in the first embodiment described above.

the requisite bandwidth Bᵢ individually corresponding the network unit 80-c (c=1 to N) (FIG. 7 (1))

the sum total ΣBᵢ of the requisite bandwidths Bᵢ (FIG. 7 (2))

The controlling part 41 also performs processing based on the following procedure.

to compute a sum total Σr of the prescribed bandwidths r of the network unit 80-c (c=1 to N) (FIG. 7 (3))

to perform an arithmetic operation which is expressed by the following formula to compute a maximum bandwidth Bₘₐₓ (FIG. 7 (4))

Bₘₐₓ=γ·ΣBᵢ+Σr

to compute a correction coefficient δ which is expressed by the following formula with respect to a sum total B_{abs} of the sharable bandwidths which can actually be allotted to the network unit 80-c (c=1 to N) as the individual shared bandwidth (FIG. 7 (5))

δ=B_{abs}/Bₘₐₓ

to perform an arithmetic operation which is expressed by the following formula to compute the individual shared bandwidth B_{c} to be allotted individually to the network unit 80-c (c=1 to N)

B_{c}=δ·(ΣBᵢ+Σr)

In other words, the sharable bandwidth to be allotted to each of the network units 80-1 to 80-N is simply computed without any computation of the record-depending bandwidth which is obtained only with the complicated iterative operation based on the aforesaid recursion formula.

Therefore, according to this embodiment, load reduction on the controlling part 41 and flexible adaptability to various communication services and forms of maintenance and operation as well as improvement in responsiveness are realized.

Incidentally, a value of the prescribed bandwidth r is not specifically shown in this embodiment.

This prescribed bandwidth r may be any value such as a peak bandwidth, a guaranteed minimum bandwidth, and others which are given to each of the network units as a contracted bandwidth as long as the value is appropriate for requests for maintenance, operation, and so on.

In this embodiment, a value for the constant γ is not specifically shown.

This constant γ may be any value as long as it is appropriate for requests for maintenance, operation, and so on similarly to the prescribed bandwidth r and furthermore, may be updated appropriately, for example, to a value appropriate for a part or all of the events and states, as listed below, which are identified based on the communication control procedure.

the cell-count C_{c}

the information content in a buffer C_{B}

the traffic distribution in the optical transmission path 71-U and/or the optical transmission path 71-D

the operation condition (including a failure) in the optical transmission path 71-D and/or the optical transmission path 71-U

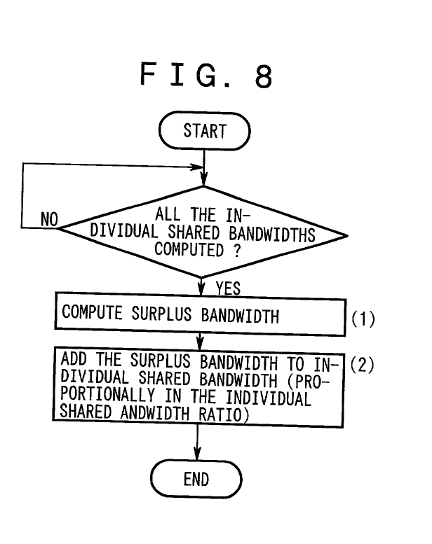

FIG. 8 is a flow chart showing operations in the fifth embodiment of the present invention.

The operations in the fifth embodiment are explained below with reference to FIG. 3 and FIG. 8.

This embodiment is characterized by the following processing procedure performed by the controlling part 41.

The controlling part 41 computes the individual shared bandwidth to be allotted to each of the network units 80-1 to 80-N based on an algorithm which may cause a bandwidth, out of the sharable bandwidth, to be left unallotted to any of the network units 80-1 to 80-N (hereinafter called a ‘surplus bandwidth’) due to all or a part of the following items.

a rounding error and a truncation error occurring in an operation process

errors accumulated in a process of the algorithm repeatedly applied for varying the bandwidth

Incidentally, since these operations are not characteristics of the present invention and are realizable under the application of the aforesaid prior art and other various known technologies, the explanations thereof are omitted here.

The controlling part 41 computes the surplus bandwidth as a complement for the sum total of the individual shared bandwidths after computing all the individual shared bandwidths to be allotted to all of the network units 80-1 to 80-N based on the above algorithm (FIG. 8 (1)).

Then, the controlling part 41 adds a bandwidth which is obtained by distributing the surplus bandwidth proportionally in an individual shared bandwidth ratio, which is computed in advance, to the corresponding individual shared bandwidth (FIG. 8 (2)).

In other words, according to this embodiment, the transmission bandwidth which can be allotted as the individual shared bandwidth is properly allotted to each of the network units 80-1 to 80-N with no transmission bandwidth being persistent uselessly.

Therefore, effective utilization of the sharable bandwidth is realized and transmission efficiency and service quality are enhanced.

Incidentally, in this embodiment, the ratio which is applied in distributing the surplus bandwidth proportionally is computed based on the computed value of the individual shared bandwidth to be allotted to each of the network units.

However, this ratio may be given, for example, as weight appropriate for either one of the following items.

a subscriber class which is set in advance for each of the network units 80-1 to 80-N

importance and a kind of a call occurring in each of the network units 80-1 to 80-N

a QoS class which is given under QoS control

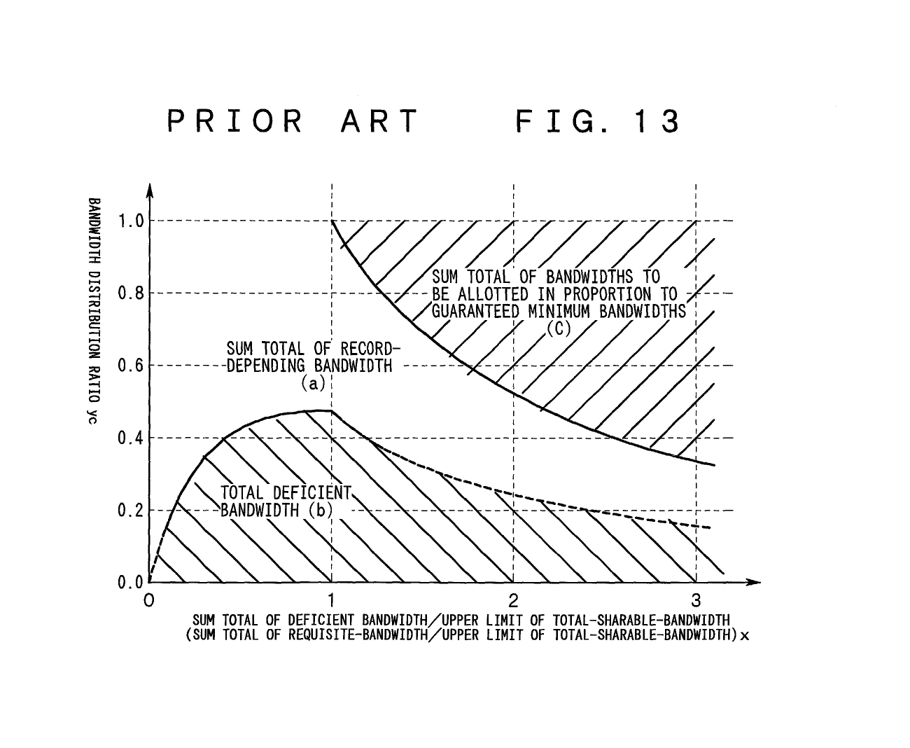

In the embodiments described above, the function which is shown by the solid line in FIG. 13 is given as a curve monotonously decreasing relative to the aforesaid x (≧1).

However, this function may be given as a function approximating in a polygonal line or a step-wise line with desired precision.

In the embodiments described above, the upstream transmission information which is received from the network units 80-1 to 80-N is given as a cell with a fixed word length and all of the bandwidths are computed as values converted to the number of the cells.

However, the present invention is not limited to this structure and, for example, all the bandwidths may be converted based on an average word length of the cells when the average word length can be considered to be fixed, even when the word lengths of the cells are not fixed.

Meanwhile, when the word lengths of the cells are widely variable, all the bandwidths may be computed in a manner in which the number of the cells are computed as a value below a decimal point with desired precision and given a proper scaling, or the bandwidths are not converted to the number of cells at all.

In the embodiments described above, a form of a packet to be transmitted to the line terminating equipment 40 as the polling request is not specifically described.

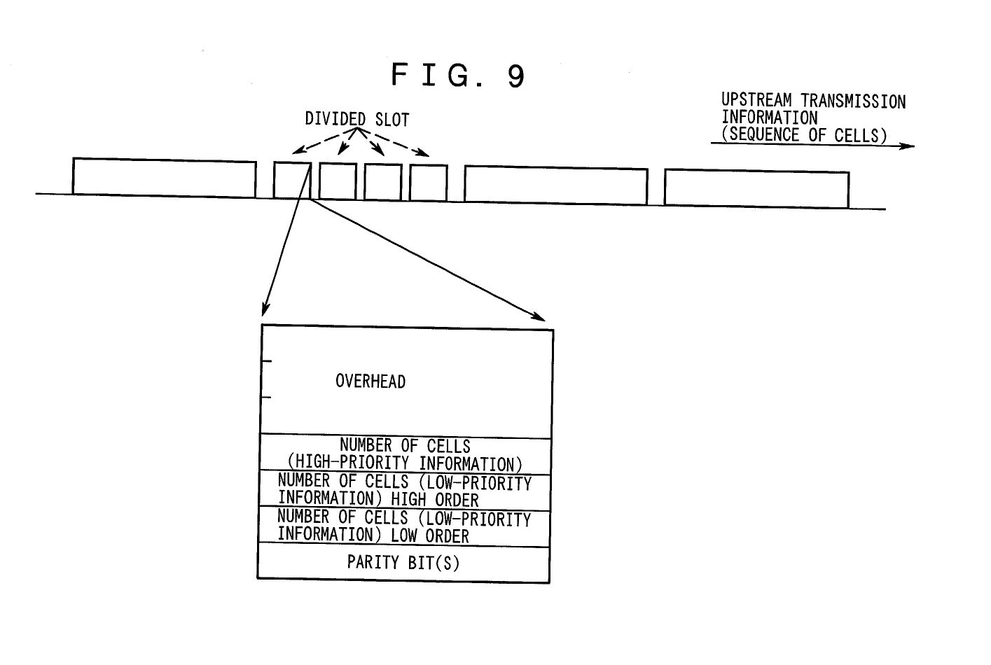

However, the polling request may be transmitted to the line terminating equipment 40 as any form of a cell, a packet, and other transmission units as long as it is consistent with the transmission system of the optical transmission path 71-U and the applied communication protocol and may be similarly transmitted, for example, as divided slots including the number of cells (including the low-priority information) which is accumulated in the transmission buffer 82C-c (when necessary, including the number of the cells accumulated in the transmission buffer 82F-c (including the high-priority information)), as shown in FIG. 9, when the present invention is applied to the ATM-PON system as in the above-described embodiments.

In the embodiments described above, the present invention is applied to the ATM-PON system which accommodates the plural network units 80-1 to 80-N via the common optical transmission paths 71-D, 71-U and constitutes an access network.

However, the present invention is not limited to be applied to the ATM-PON system and is applicable to various networks regardless of whether or not all or a part of transmission sections of the transmission channel are constituted as optical transmission paths and regardless of transmission systems and communication protocols thereof as long as the network to which the present invention is applied is a network in which the transmission bandwidth to be secured for a plurality of network units via a common transmission channel based on a predetermined transmission system and communication protocol is appropriately updated.

The present invention is not limited to the above embodiments and various modifications may be made without departing from the spirit and the scope of the invention. Any improvement may be made in part or all of the components.

What is claimed is:

1. A line terminating equipment comprising:
a requisite-bandwidth computing section for computing a requisite bandwidth for individual terminals as an increasing function of receipt information content and untransmitted information content, the receipt information content being content of transmission information precedingly received from the terminals, the untransmitted information content being notified by the terminals; and
a transmission-band determining section for determining a transmission bandwidth to be allotted to said individual terminals in a manner which is determined according to a comparison result of magnitude between a sum total of the requisite bandwidths and the transmission band of a transmission channel.

2. The line terminating equipment according to claim 1, wherein:
a known transmission bandwidth is allotted individually and constantly to all or a part of said terminals;
said untransmitted information content is notified as content of transmission information to be transmitted via a transmission bandwidth other than said known transmission bandwidth;
said receipt information content is measured as content of transmission information which is received via a transmission bandwidth other than said known transmission bandwidth; and
a transmission bandwidth to be allotted to each of said terminals is a transmission bandwidth other than said known transmission bandwidth.

3. A line terminating equipment comprising:
a requisite-bandwidth computing section for computing a requisite bandwidth for individual terminals as an increasing function of receipt information content and untransmitted information content, the receipt information content being content of transmission information precedingly received from the terminals, the untransmitted information content being notified by the terminals; and
a transmission-band allotting section for allotting a transmission bandwidth to said individual terminals, the transmission bandwidth being equal to a product of the computed requisite bandwidth and a ratio δ, the ratio δ being a ratio of a transmission bandwidth of a transmission channel to a sum of: a product of a sum total of the requisite bandwidths and a coefficient γ(>1); and a sum total of minimum transmission bandwidths to be allotted to said individual terminals.

4. The line terminating equipment according to claim 3, wherein:
a known transmission bandwidth is allotted individually and constantly to all or a part of said terminals;
said untransmitted information content is notified as content of transmission information to be transmitted via a transmission bandwidth other than said known transmission bandwidth;
said receipt information content is measured as content of transmission information which is received via a transmission bandwidth other than said known transmission bandwidth; and
the transmission bandwidth to be allotted to each of said terminals is a transmission bandwidth other than said known transmission bandwidth.

5. A line terminating equipment comprising:
an interfacing section for interfacing with a transmission channel formed in common between the interfacing section and a plurality of terminals;
a receipt-information-content measuring section for measuring receipt information content which is content of transmission information received from said plurality of terminals;
an untransmitted-information-content collecting section for collecting untransmitted information content which is content of transmission information which is notified by said plurality of terminals, accumulated in the terminals, and has not been completely transmitted;
a requisite-bandwidth computing section for computing a requisite bandwidth for each of said plurality of terminals as an increasing function of the receipt information content measured and the untransmitted information content collected, the requisite bandwidth being a transmission bandwidth necessary to be allotted, the transmission bandwidth being a transmission bandwidth of said transmission channel;
a record-depending-bandwidth computing section for computing a record-depending bandwidth to be further allotted for each of said plurality of terminals, as an increasing function of a transmission bandwidth precedingly allotted and the receipt information content measured; and
a transmission-band allotting section for
allotting a sum of a deficient bandwidth and a bandwidth to said plurality of terminals via said interfacing section and said transmission channel when a sum total of the computed requisite bandwidths is smaller than the transmission bandwidth of said transmission channel, the deficient bandwidth being given as an increasing function of the untransmitted information content collected, the bandwidth being obtained by proportionally distributing a surplus bandwidth other than the deficient bandwidth in the proportion of the computed record-depending bandwidth to the whole record-depending bandwidth, and
allotting a sum of bandwidths of a minimum transmission band to be individually allotted to said plurality of terminals and a bandwidth obtained by proportionally distributing a surplus bandwidth other than the minimum transmission bandwidth in the proportion of the sum of the deficient bandwidth and the bandwidth to the sum total of the deficient bandwidths and the bandwidths when the sum total of the requisite bandwidths exceeds the transmission bandwidth of said transmission channel.

6. The line terminating equipment according to claim 5, wherein:
a known transmission bandwidth is allotted individually and constantly to all or a part of said terminals;
the untransmitted information content is content of transmission information to be transmitted via a transmission bandwidth other than the known transmission bandwidth, the transmission information being accumulated in said plurality of terminals and having not been completely transmitted;
said receipt-information-content measuring section measures, as said receipt information content, content of transmission information received via the transmission bandwidth other than said known transmission bandwidth, the transmission information being included in the transmission information received from said plurality of terminals; and
said record-depending-bandwidth computing section uses a transmission bandwidth other than said known transmission bandwidth as the transmission bandwidth precedingly allotted.

7. The line terminating equipment according to claim 5, further comprising
a communication controlling section for performing communication control relating to said transmission channel via said interfacing section, and wherein
said requisite-bandwidth computing section computes said requisite bandwidth as an increasing function having increasing rates for the receipt information content measured and the untransmitted information content collected, the rates being suitable for an event and/or a state identified in a process of said communication control.

8. The line terminating equipment according to claim 5, wherein
said transmission-band allotting section computes a deficient bandwidth given as an increasing function of both the untransmitted information content collected and the receipt information content measured, and uses the deficient bandwidth for computation when the sum total of the computed requisite bandwidths is smaller than the transmission bandwidth of said transmission channel.

9. The line terminating equipment according to claim 8, wherein
said transmission-band allotting section computes a deficient bandwidth given as a monotone nondecreasing function of the untransmitted information content, and uses the deficient bandwidth for computation when the sum total of the computed requisite bandwidths is smaller than the transmission bandwidth of said transmission channel.

10. A line terminating equipment comprising:
an interfacing section for interfacing with a transmission channel formed in common between the interfacing section and a plurality of terminals;
a receipt-information-content measuring section for measuring receipt information content which is content of transmission information received from said plurality of terminals;
an untransmitted-information-content collecting section for collecting untransmitted information content which is content of transmission information which is notified by said plurality of terminals, accumulated in the terminals, and has not been completely transmitted;
a requisite-bandwidth computing section for computing a requisite bandwidth for each of said plurality of terminals as an increasing function of the receipt information content measured and the untransmitted information content collected, the requisite bandwidth being a transmission bandwidth necessary to be allotted, the transmission bandwidth being of a band of said transmission channel; and
a transmission-band allotting section for allotting a transmission bandwidth to said plurality of terminals via said interfacing section and said transmission channel, the transmission bandwidth being equal to a product of the computed requisite bandwidth and a ratio δ, the ratio δ being a ratio of the transmission bandwidth of said transmission channel to a sum of: a product of a sum total of the computed requisite bandwidths and a coefficient γ(>1); and a sum total of minimum transmission bandwidths to be allotted to the individual terminals.

11. The line terminating equipment according to claim 10, wherein:
a known transmission bandwidth is allotted individually and constantly to all or a part of said terminals;
the untransmitted information content is content of transmission information to be transmitted via a transmission bandwidth other than the known transmission bandwidth, the transmission information being accumulated in said plurality of terminals and having not been completely transmitted; and
said receipt-information-content measuring section measures, as said receipt information content, content of transmission information received via the transmission bandwidth other than said known transmission bandwidth, the transmission information being received from said plurality of terminals.

12. The line terminating equipment according to claim 10, further comprising
a communication controlling section for performing communication control relating to said transmission channel via said interfacing section, and wherein
said requisite-bandwidth computing section computes said requisite bandwidth as an increasing function having increasing rates for the receipt information content measured and the untransmitted information content collected, the rates being suitable for an event and/or a state identified in a process of said communication control.

13. The line terminating equipment according to claim 5, wherein
said transmission-band allotting section monitors, based on a processing procedure of allotting the transmission bandwidth to said plurality of terminals, a sum total of surplus transmission bandwidths which are left unallotted to any of the terminals due to attribute and operation precision of an algorithm applied to the processing, and allots the surplus transmission bandwidths in the proportion of a prescribed bandwidth set in advance or given for each of the terminals to the whole prescribed bandwidth.

14. The line terminating equipment according to claim 10, wherein
said transmission-band allotting section monitors, based on a processing procedure of allotting the transmission bandwidth to said plurality of terminals, a sum total of surplus transmission bandwidths which are left unallotted to any of the terminals due to attribute and operation precision of an algorithm applied to the processing, and allots the surplus transmission bandwidths in the proportion of a prescribed bandwidth set in advance or given for each of the terminals to the whole prescribed bandwidth.

15. The line terminating equipment according to claim 10, wherein
the minimum transmission bandwidth to be individually allotted to said plurality of terminals is given as a contracted bandwidth of the terminals.

16. The line terminating equipment according to claim 5, wherein
said record-depending-bandwidth computing section computes the record-depending bandwidth for a terminal as an increasing function having a value equal to a prescribed bandwidth set in advance or given, even when the receipt information content measured and the untransmitted information content collected of the terminal are ‘0’.

17. The line terminating equipment according to claim 5, wherein
one or both of the increasing function by which the requisite bandwidth is obtained and the increasing function by which the record-depending bandwidth is obtained is/are increasing function(s) where errors in the requisite bandwidth and the record-depending bandwidth of all of said plurality of terminals are permissibly small.

18. The line terminating equipment according to claim 10, wherein
one or both of the increasing function by which the requisite bandwidth is obtained and the increasing function by which the record-depending bandwidth is obtained is/are increasing function(s) where errors in the requisite bandwidth and the record-depending bandwidth of all of said plurality of terminals are permissibly small.

19. The line terminating equipment according to claim 5, wherein
one or both of the increasing function by which the requisite bandwidth is obtained and the increasing function by which the record-depending bandwidth is obtained is/are approximate function(s) where errors in the requisite bandwidth and the record-depending bandwidth of all of said plurality of terminals are permissibly small.

20. The line terminating equipment according to claim 10, wherein
one or both of the increasing function by which the requisite bandwidth is obtained and the increasing function by which the record-depending bandwidth is obtained is/are approximate function(s) where errors in the requisite bandwidth and the record-depending bandwidth of all of said plurality of terminals are permissibly small.

21. The line terminating equipment according to claim 5, wherein:
the transmission information to be received from said plurality of terminals is a sequence of transmission units whose word lengths are fixed or can be considered to be fixed; and
said receipt information content, said untransmitted information content, said requisite bandwidth, said record-depending bandwidth, and all transmission bandwidths are given as a ratio of the transmission bandwidth of said transmission channel to said word lengths or an average of said word lengths.

22. The line terminating equipment according to claim 10, wherein:
the transmission information to be received from said plurality of terminals is a sequence of transmission units whose word lengths are fixed or can be considered to be fixed; and
said receipt information content, said untransmitted information content, said requisite bandwidth, said record-depending bandwidth, and all transmission bandwidths are given as a ratio of the transmission bandwidth of said transmission channel to said word lengths or an average of said word lengths.
